(19) United States
(12) Patent Application Publication
(10) Pub. No.: US 2004/0227623 A1
(43) Pub. Date: Nov. 18, 2004

(54) Network topology and packet routing method using low voltage power wiring

(75) Inventor: Andrew Pozsgay, Germantown, MD (US)

Correspondence Address: Baker & Hostetler LLP, Washington Square, Suite 1100, 1050 Connecticut Avenue, N.W., Washington, DC, 20036, US

(73) Assignee: Telkonet, Inc.

(21) Appl. No.: 10/872,869

(22) Filed: Jun. 22, 2004

Related U.S. Application Data
(63) Continuation-in-part of application No. 10/430,282, filed on May 7, 2003.

(51) Int. Cl. H04M 11/04; H04L 12/56

(52) U.S. Cl. 340/310.01; 370/400

(57) ABSTRACT

A network topology and packet routing method for implementing a Local Area Network (LAN) using low-voltage (120/240VAC) power wiring as the transport medium. An Access Point (AP) having a Power Line Carrier (PLC) interface and one or more IEEE 802.3 Ethernet interfaces connects to the logical center of the Power Line medium via its PLC interface. Multiple User Terminals (UT) send to and receive from their associated AP, which in turn routes data packets toward the appropriate destination. Large networks may contain more than one AP, in which case each UT selects its AP based on a metric representing connection quality between the UT and the AP.

This continuation-in-part application claims priority to U.S. patent application Ser. No. 10/430,282 filed on May 7, 2003 entitled “Network Topology & Packet Routing Using Low-Voltage Power Wiring” the contents of which are incorporated by reference in their entirety. This application also claims priority to U.S. patent application Ser. No. 09/781,346 filed on Feb. 12, 2001 entitled “Method & Apparatus for Providing Telephonic Communications Services” the contents of which are incorporated by reference in their entirety.

### FIELD OF THE INVENTION

The invention relates to packet data networks in general and in particular to topologies and packet routing methods in Local Area Networks (LANs) implemented using Power Line Carrier (PLC) technology.

### BACKGROUND OF THE INVENTION

In-building LANs are commonly implemented over twisted-pair cabling using the IEEE 802.3 access method and physical layer specification. Using this method, one or more hubs or switches can be installed in centralized location(s) in the building, typically a wiring closet. Twisted-pair cabling is run from this closet to each user location, one cable per user. All hubs/switches are then connected together using the same type cable.

One advantage of this wired method is that twisted-pair cabling provides a reliable communications medium capable of rejecting external interference. Another advantage is each user can use the full capacity of the medium without having to share it with others provided that switches are used as the interconnects. A disadvantage of twisted-pair cabling is the expense of the cable installation. If the cabling is installed at the time of building construction, the task is fairly straightforward. However, for existing buildings that did not have such cabling installed at the time of construction retrofitting such buildings can be a prohibitively large and complex task.

In situations where twisted-pair cable installation is not practical, PLC is an attractive alternative. The Power Line as a communications medium presents challenges to the system designer, including accounting for impedances that vary with frequency and time as well as noise sources from appliances connected to the network. It has been shown, however, that advanced modulation techniques, such as Orthogonal Frequency Division Multiplexing (OFDM), along with error control coding can overcome these challenges and make low-voltage AC power lines usable as a communications channel using the relatively quiet spectrum above 1 MHz.

FIG. 1 depicts an example of a typical electrical wiring installation for a small to medium size commercial building. The thick lines represent high-current 3-phase wiring and the thin lines represent lower-current (15A-20A) wiring. The shaded boxes represent outlets, which are the locations at which users can access the network via a user terminal (UT).

At the frequencies of interest to PLC, this wiring network does not present a controlled impedance. Impedance discontinuities exist at every wire termination point, including outlets and panel connections. As an example, the path between outlet A and outlet B contains 9 impedance discontinuities (A1, A2, A3, Sub Panel 1, Main Panel, Sub Panel 2, B3, B2, B1). Upon reaching each one of these discontinuities, some signal power is reflected back toward the transmitter to impair the channel. Further, reflected energy reaching another discontinuity can cause some of the reflected energy to again reflect towards the receiver.

The electrical panels introduce another mechanism to impair the channel. When a signal encounters a panel, some power flows out through each wire connected to the panel. In this way, the panel acts as a power divider. The panel attenuates the signal because only a fraction of the power sent into the panel goes toward the intended destination. The rest of the power is effectively lost.

It can be seen that a user on a subpanel 1 outlet attempting to communicate directly with a user on a subpanel 2 outlet encounters a number of channel impairments. As an example, the path from outlet A, to outlet B, contains 9 separate sources of channel impairment 6 of these are outlet terminations, which mainly insert impedance discontinuities. The other 3 are panels which insert attenuation in addition to impedance discontinuities.

Whereas in the electrical installation depicted in FIG. 1 uses 120V/220V wiring to distribute electrical power within the building, it is also common to use a higher voltage such as 480V for long high-power runs and then step down to 120V for local distribution. The higher voltage reduces the current which allows use of a smaller-gauge wire. FIG. 2 depicts such an installation. The power transformers commonly used in these applications present a significant barrier for signals in the PLC frequency range, further decreasing the likelihood that a node can directly communicate with a node on a different subpanel.

### SUMMARY OF THE INVENTION

The advantages of using the disclosed methods and systems are notable not just for their apparent utility, but also because they transcend any other known approach that uses power lines as a basis for LAN-type communications due in part on the novel topology approaches described.

The invention is a network topology and packet routing method for providing LAN connectivity over in-building AC power wiring. The network consists of one or more APs, one or more UTs, and the power wiring (the medium). The AP(s) is (are) installed in locations representing the logical center of the entire in-building wiring network or the center of a portion of it. The UTs communicate only with their corresponding AP, who in turn routes the packets toward their destination.

It is an Object of the present invention to provide a system using a Power Line Carrier for network communication by installing an AP at one or more electrical panels and connecting these APs together using standard Ethernet links over twisted-pair cabling. For network management purposes, it is desirable to designate one of the APs as a primary and the others secondaries. Therefore, this network contains three types of device: Primary AP, Secondary AP, and UT.

It is clear that by inserting an Access Point (AP) at the Main panel, and routing all packets through that AP, the worst-case scenario for a channel between any two users is significantly improved. Instead of a single hop with 9 impairments (6 outlets and 3 panels), a user on outlet A can reach a user on outlet B via 2 hops with 5 impairments each (3 outlets and 2 panels). In a building of sufficient size, the insertion of one or more APs will enable communication between users who previously could not communicate with each other.

In a multi-AP installation, a given UT may be able to communicate to some degree with more than one AP. In this case, the UT selects the most appropriate AP to use by estimating the speed with which it can communicate with each AP and selecting the AP with which it can communicate with at the highest rate.

Nodes which make use of the invention are referred to as endpoints. Endpoints can be connected to the Ethernet interface of either an AP or a UT, possibly through one or more standard Ethernet hubs or switches. The present invention provides transport of Ethernet frames from a source endpoint to one or more destination endpoints.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 has a typical electrical wiring installation for a small to medium size commercial building or multi-tenant unit.

FIG. 2 has a installation similar to FIG. 1 using a medium voltage feed and step down transformer.

FIG. 2a illustrate connections between access points (AP) of different sub-panels.

FIG. 3 shows the architecture which make up the primary access point (PAP), the secondary access point (SAP) and the user terminal (UT) hardware in the present invention.

FIG. 4 is a schematic illustrating an example of the user terminal hardware environment.

FIG. 5a shows a structure for frames which are received from or transmitted to a user terminal and which have a standard Ethernet frame structure according to EEE 802.3 format.

FIG. 5b illustrates a structure for frames transferred over power wiring (PLC).

FIG. 5c shows structure for frames transferred between a primary access point (PAP) and a secondary access point (AP).

FIG. 6a is a table stored in the PAP with indexing of the SAPs;

FIG. 6b is a Proxy table in the PAP indexing the user terminals (UT).

FIG. 6c is a PAP table of all end points.

FIG. 6d is a listing of entries in a UT Ethernet end point table.

FIG. 7 is a flow chart of PAP packet processing.

FIG. 8a is a flow chart of the transmission of a frame to a UT.

FIG. 8b is a flow chart of the power line broadcast method.

FIG. 9 is a flow chart of SAP processing flow.

FIG. 10 is a flow chart of UT processing flow.

FIG. 11 depicts the wiring system of FIG. 1 with access points at all the wiring centers.

FIG. 12 depicts the wiring system of FIG. 11 modified with an added Ethernet communication line.

FIG. 13 depicts the wiring system of FIG. 12 modified with a second added Ethernet communication line.

FIG. 14 is a flowchart outlining a second exemplary operation for transferring data between two user terminals using any of the networks depicted in FIGS. 11-13.

FIG. 15 is a flowchart outlining a third exemplary operation for transferring data between two user terminals using any of the networks depicted in FIGS. 1, 2, 3 and 11-13.

FIG. 16 is a flowchart outlining an exemplary operation for substantially optimizing traffic over the power line networks shown in FIGS. 11-13.

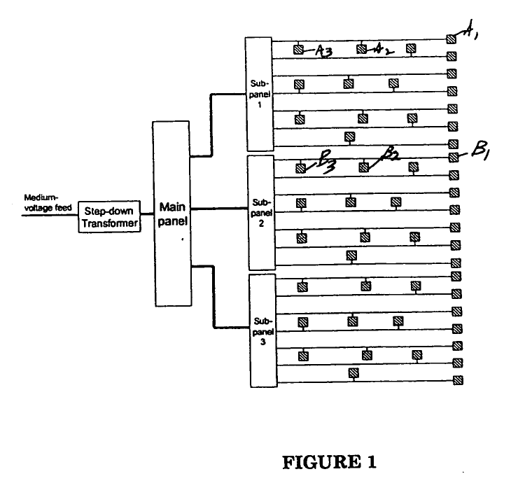

### DETAILED DESCRIPTION

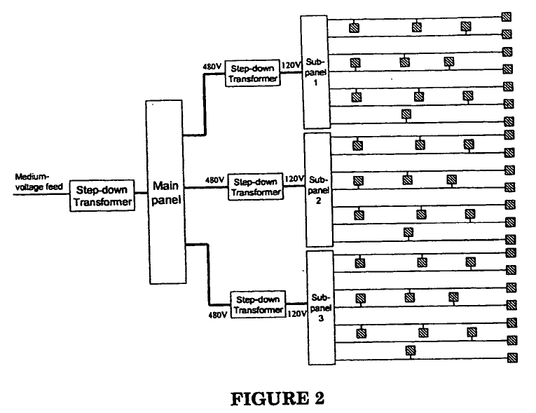

FIG. 2a show a connection of access points 11 and 17 within sub-panels 10 and 16. User terminals 20 and 20′ are connected to the respective access point 11 and 17 by the power line carrier. Communication between access points 11 and 17 is accomplished through an Ethernet connection directed by hub 15. All signals received by hub 15 are directed to all access points with the receipt of these signals based on the address so that access points for which signals are not destined will not be accepted. Although structure 15 is shown as a hub, in other embodiments device 15 can be an Ethernet switching device used whereby signals are not sent to all Access Points (AP) but only to the intended Access Points (AP). Additionally, signals may be sent from the hub (15) to external devices such as the Internet.

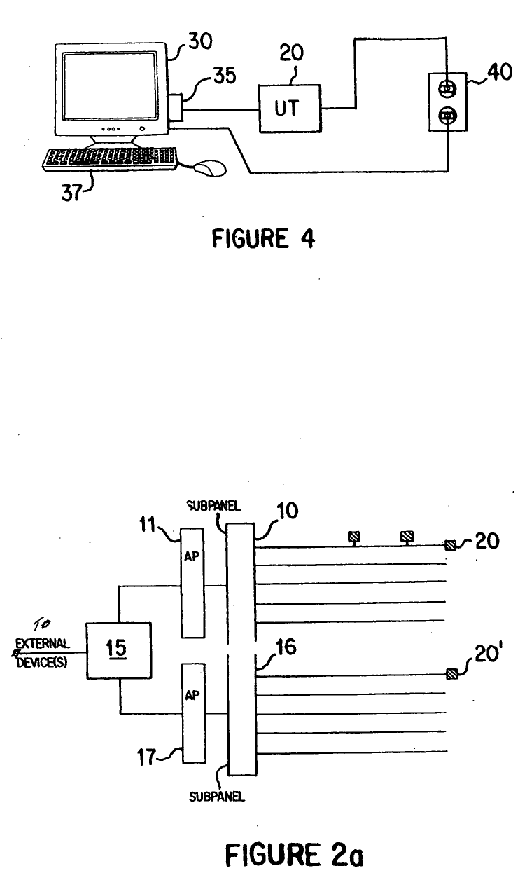

The Primary AP (PAP), Secondary AP (SAP), and UT hardware all share the common architecture depicted in FIG. 3, which can be viewed as a microprocessor with two interfaces: one Ethernet and one PLC. The Ethernet interface works as follows. The Ethernet MAC (Medium Access Protocol) sends and receives IEEE 802.3 Ethernet frames using the Ethernet Physical Layer (PHY) transceiver, which in turn connects to a twisted-pair medium. Frames received on the twisted-pair are demodulated by the PHY, forwarded on to the MAC for frame synchronization and error-checking, and then placed in the shared RAM to be read by the microprocessor. Frames to be transmitted on the twisted-pair are written to the shared RAM, read by the MAC, and then transmitted on the medium via the PHY.

The PLC interface is similar to the Ethernet interface in that it sends and receives similarly formatted frames and the data path is the same. The main differences are in the nature of the MAC and PHY. The modulation method used by the PHY is one appropriate for use over a power wiring network. Similarly, the medium access protocol used by the MAC is one optimized to perform well under the channel conditions found in a power wiring network.

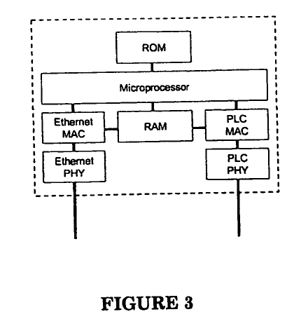

The user terminal UT constructed in accordance with FIG. 3 is part of an end point structure of the type illustrated in FIG. 4 wherein User Terminal 20 is shown as receiving an output from Ethernet card 35 of the PC 30 with its associated input keyboard 37. The output of User Terminal 20 is fed to the ordinary power line connection point 40 having 2 terminals. One of the terminals is connected as a source of power for the PC while the other carries the output signal from the user terminal to be provided for transmission over the PLC (power line carrier). Although the user terminal is shown as outside of the PC, in another embodiment it could be positioned inside the PC in addition to or as par] of the Ethernet card.

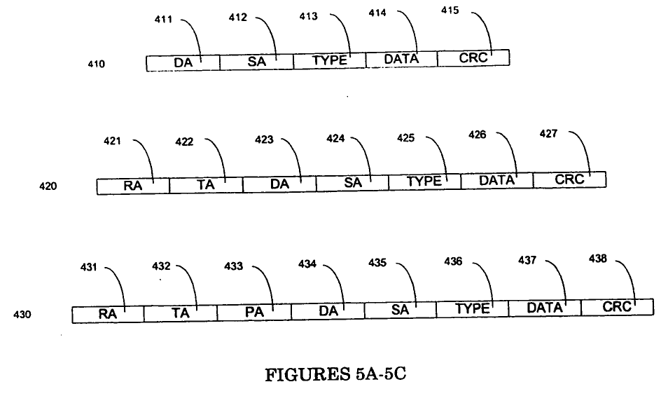

When a frame is received on either the PLC or the Ethernet interface, the frame is written to RAM and the microprocessor is notified of the frame's arrival. The microprocessor examines the frame header and, based on this header and the contents of bridging tables stored in RAM, retransmits the frame on one or both interfaces, possibly modifying the header first. Frames transferred over twisted-pair Ethernet can be either External frames or AP-to-AP frames. External frames are standard Ethernet frames which are received from or transmitted to an endpoint, and have the standard IEEE 802.3 format (410) illustrated in FIG. 5a.

The Destination Address (DA) (411) is a 48-bit Ethernet address representing the ID of the station that is the intended recipient of the frame. The Source Address (SA) (412) is a 48-bit Ethernet address representing the ID of the station that is the originator of the frame. These fields are preserved as the frame passes through an Ethernet-to-Ethernet MAC layer bridge. The TYPE (413) field is a 16-bit identifier that is also referred to as the protocol ID. This field indicates which higher-layer protocol the frame belongs to, and defines the format of the variable-length DATA section (414). The CRC (Cyclic Redundancy Check) (415) is a 16-bit field used to verify the integrity of the frame.

Frames transferred over power wiring have the format of (420) as shown in FIG. 5b. The Receiver Address (RA) (421) is an address representing the ID of the PLC interface that the frame is immediately directed toward. The Transmitter Address (TA) (422) represents the ID of the PLC interface transmitting the frame. The remaining fields have the same meaning as in (410).

AP-to-AP frames are transferred between the PAP and a SAP and have the format of (430) shown in FIG. 5c. The RA (431) represents the frame's immediate receiver, and will either be the address of the PAP or a SAP, depending on the frame's direction. AP-to-AP frames can be either downstream or upstream. Downstream frames originate from a non-AP node connected off the PAP's Ethernet interface and terminate at a node connected to a UT. Upstream frames originate from a node connected to a UT and terminate at a non-AP node connected off the PAP's Ethernet interface. The Proxy Address (PA) (433) field represents the address of the UT which is “proxy” for the DA node. For downstream frames, the SAP forwards the frame to the UT whose address is PA (433), and this UT in turn forwards the frame to its Ethernet interface, where the frame reaches the endpoint with address DA (434). For upstream frames, the PA (433) is used by the PAP to allow it to maintain its table of UTs, and endpoints reachable via each.

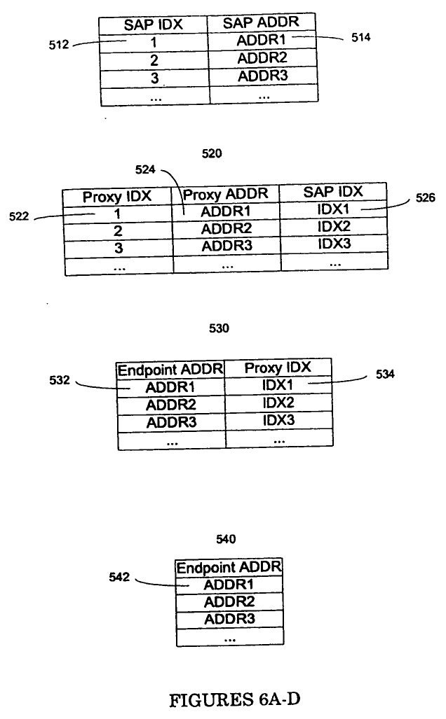

The differences between the PAP, SAP, and UT device types is in the way frames are routed between the two interfaces. The majority of the routing decision making is done at the PAP, which uses tables stored in its RAM in the decision process. One of these tables is the SAP table (510) of FIG. 6a, which is an indexed table of SAPs the PAP is aware of. The SAP IDX (512) of zero is reserved to represent the PAP.

Also in the PAP is the Proxy Table (520) of FIG. 6b, which is an indexed table of UTs the PAP is aware of. The Proxy IDX (522) of zero is as in (410) are reserved to represent the PAP Ethernet interface. The SAP IDX (526) represents the index of the SAP (512) in which the UT is reachable through. A SAP IDX (526) of zero means the UT is reachable directly via the PAP's PLC interface.

A third PAP table is the Endpoint Table (530) of FIG. 6c, which is a table of all endpoints the PAP is aware of.

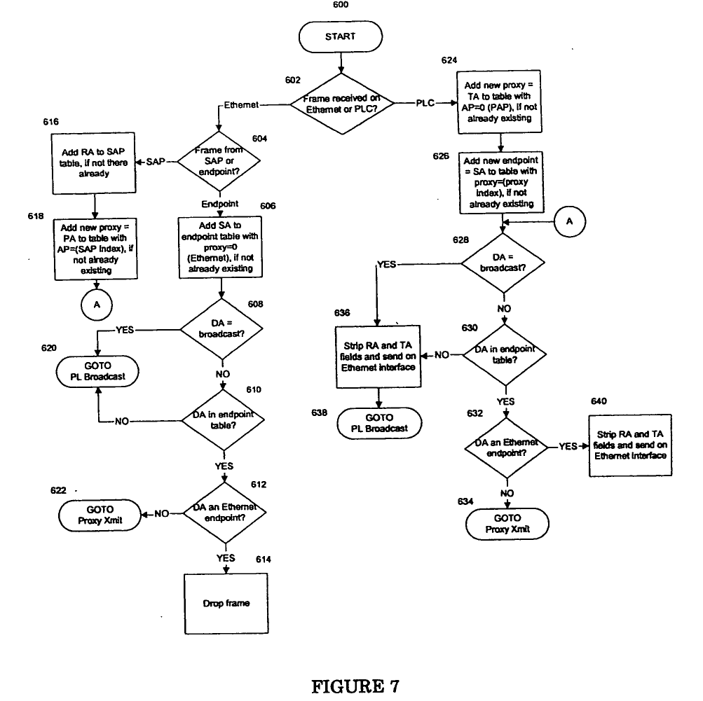

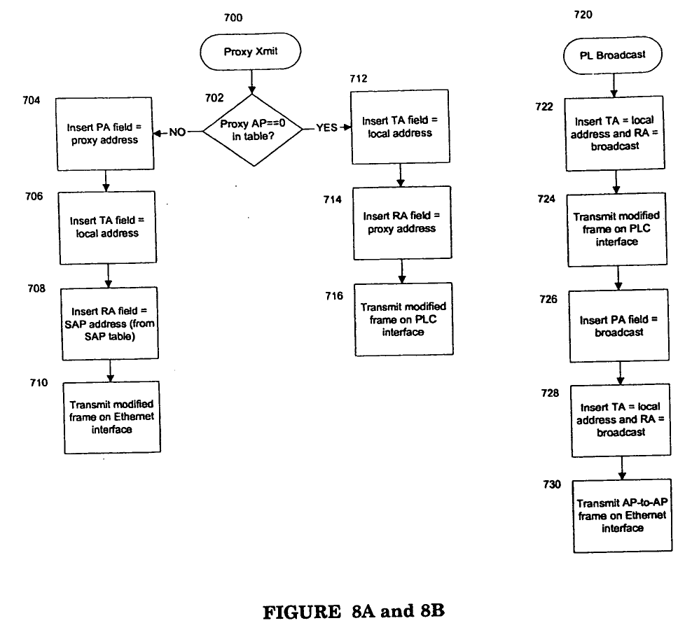

The PAP packet processing flow is illustrated in (600) of FIG. 7. A frame received on the PLC interface is could have only come from a UT (proxy) and is in the format of (420). The TA (422) is the proxy address and is added to the proxy table if a corresponding entry does not already exist (624). The SAP IDX field (526) corresponding to this entry is set to zero to indicate the proxy is reachable directly from the PAP. The SA (424) is the source address of the endpoint that sent the frame and this endpoint is added (626) to the endpoint table (530) if it does not already exist. The Proxy IDX (534) corresponding to the endpoint is set to the index of the proxy in the proxy table (522) corresponding to the TA (422). The DA field (423) is then examined (628) to determine if the frame is a broadcast type. If it is, the RA (421) and TA (422) fields are removed from the frame the remaining frame is transmitted on the Ethernet interface (636). Also, the frame is broadcast to all powerline nodes by means of the PL Broadcast method (720) shown in FIG. 8b. If the frame is not a broadcast, the DA (423) is compared against all nodes (630) in the endpoint table (530) to determine if the location of the destination node is known. If the DA (423) does not match any node in the endpoint table (530), control transfers to block (536) and the frame is sent out to the Ethernet interface and all proxies. If the DA (423) does match an endpoint table (530) entry, the proxy index field for that entry (534) is examined (632) to determine the location of the destination endpoint. If the Proxy IDX (534) equals zero, the endpoint is located on the Ethernet interface and the frame is transmitted there (640). If the Proxy IDX (534) is nonzero, the endpoint is located off a proxy and control transfers to the Proxy Xmit method (700) shown in FIG. 8a.

A frame received on a PAP's Ethernet interface is examined to determine if it came from a SAP or an endpoint (604). If it is from a SAP, it is in the format of (430) and the RA (431). is compared against the ADDR fields (514) of the SAP table (510), and the SAP is added to the table if it does not already exist (616). Then the PA field (433) is compared against the ADDR fields (524) of the proxy table (520), and a new proxy is added with ADDR=PA if one does not already exist (618). Control is then transferred to point (627). If the frame came from an endpoint, it is in the format of (410) and the SA (412) is compared against the ADDR fields (532) of all entries in the endpoint table (530) and a new entry is created if no match is found (606). Then the DA (411) is examined to determine if the frame is a broadcast type (608). If it is a broadcast, control transfers to the PL Broadcast method (720) shown in FIG. 8b. Otherwise, the DA (411) is searched in the ADDR fields (532) of the endpoint table (610). If the DA (411) is not found, control transfers to the PL Broadcast method (720). If there is a match, the Proxy IDX field (534) is examined (612) to determine the location of the destination endpoint. If the Proxy IDX (534) equals zero, the endpoint is located on the Ethernet interface and the frame is dropped because it has already reached its destination. If the Proxy IDX (534) is nonzero, the endpoint is located off a proxy and control transfers to the Proxy Xmit method (700).

The Proxy Xmit method (700) transmits a frame to a UT, either directly over the PLC interface or indirectly through a SAP. The SAP IDX field (526) in the proxy table is examined (702) to determine the route to reach the proxy. If SAP IDX (526) equals zero, the frame is sent on the PLC interface in the format of (420). The TA (422) field is set to the PAP address (712), the RA field (421) is set to the proxy address (714), and the frame is transmitted on the PLC interface (716). If SAP IDX (526) is nonzero, the frame is sent on the Ethernet interface in the format of (430). The PA field (433) is set to the proxy address (704), the TA field (432) is set to the PAP address (706), the RA field (431) is set to the address of the SAP corresponding to the SAP IDX (526) (708), 0.15 and the frame is sent on the Ethernet interface (710).

The PL Broadcast method (720) sends a frame such that it reaches all endpoints reachable via a UT. To do this, the frame is broadcast on the PLC interface in the format of (420) and also broadcast on the Ethernet interface to all SAPs in the format of (430). For the PLC transmission, the TA (422) is set to the PAP address and the RA (421) is set to the broadcast address (722), and the frame is sent on the PLC interface (724). For the Ethernet transmission, the PA field (433) is set to the broadcast address (726), the TA (432) is set to the PAP address, and the RA (431) is set to the broadcast address (728), and the frame is transmitted on the Ethernet interface (730).

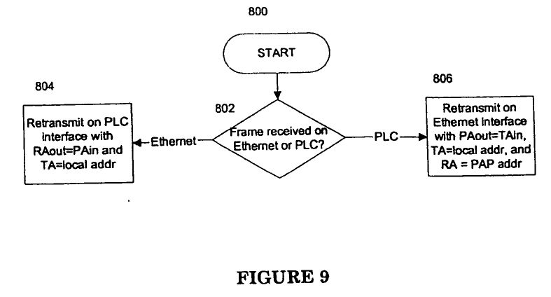

The SAP processing flow (800) is illustrated in FIG. 9. Frames received on the Ethernet interface are in the format of (430), and retransmitted on the PLC interface in the format of (420). The RA field (421) is set to the PA field (433) of the incoming frame and the TA field (422) is set to the SAP address (804). Frames received on the PLC interface are in the format of (420), and retransmitted on the Ethernet interface in the format of (430). The PA field (433) is set to the TA field (422) of the incoming frame, the TA field (432) is set to the SAP address, and the RA field (431) is set to the PAP address (806). Each SAP knows the address of the PAP because the PAP periodically broadcasts a frame in the format of (410), which announces itself as the PAP.

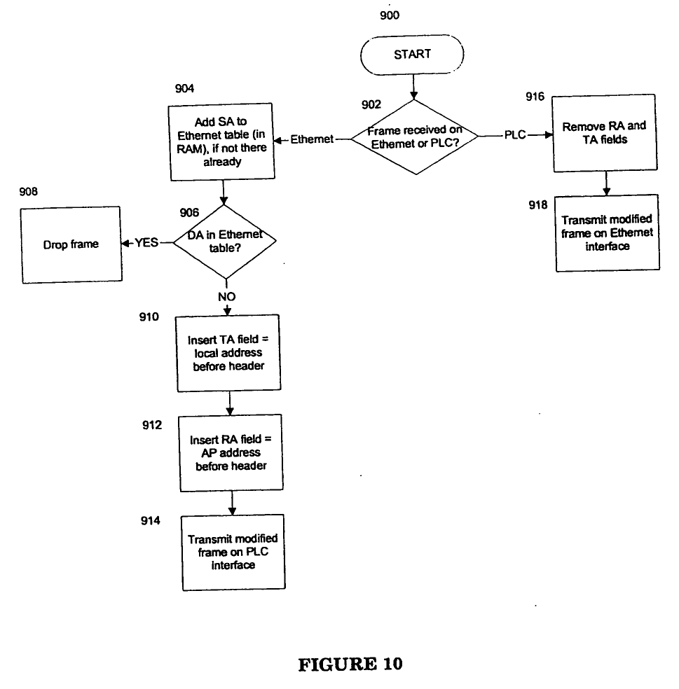

The UT processing flow (900) is illustrated in FIG. 10. When a frame is received on the Ethernet interface, its SA (412) is compared (904) against all entries in the UT Ethernet endpoint table, which has the format of (540) of FIG. 6d, and a new entry (542) is added if no match exists. Then, the DA (411) is compared (906) against entries in the same table (540). If the DA (411) exists, the frame is discarded (908). If the DA (411) does not exist, the frame is sent out on the PLC interface in the format of (420). The TA field (422) is set to the UT address (910) and the RA field (421) is set to the AP address (912). This AP address can be the address of the PAP or the address of a SAP, depending on which AP the UT selected as its AP. When a frame is received on the PLC interface, the RA (421) and TA (422) fields are stripped off (916) and the frame is sent (918) on the Ethernet interface in the format of (410). The following procedure is used by each UT to select its AP. The PAP and all SAPs periodically broadcast a frame in the format of (410) on their PLC interface, announcing themselves as an AP. Any UT capable of joining the network will be able to receive these frames from one or more APs. If a UT can receive these frames from only one AP, it selects that AP. If the UT can receive these frames from two or more APs, it estimates its connection speed with each AP, and selects the one with the highest speed. This connection speed may be obtained via several methods. This metric may be generated by the PLC MAC function and passed up to the packet routing function. Otherwise, the packet routing function may send a special frame type to each AP, which the AP immediately sends back to the UT. The UT measures the time elapsed between sending and receiving the packet, and selects the AP which it received the frame back from in the shortest time.

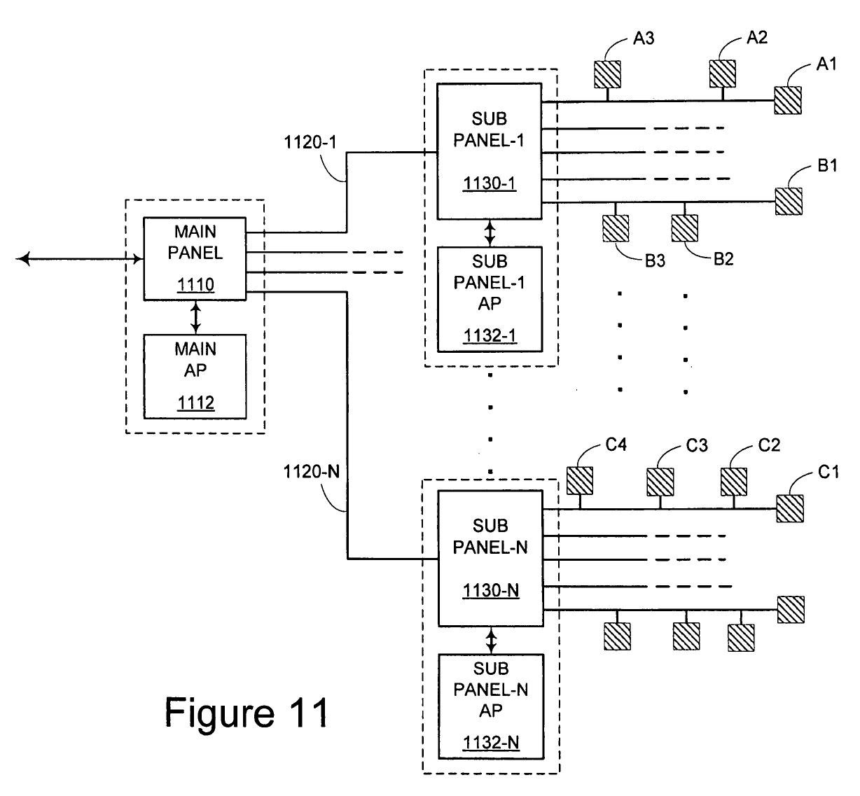

In a large enough building the insertion of a single AP at a main panel may not provide adequate coverage. Similarly, installation of APs at only the subpanels may not provide adequate coverage. In such cases, APs can be installed at both the main panel and the subpanels. FIG. 11 depicts such an exemplary variant of a power line based network. As shown in FIG. 11, the network includes a main panel 1110 having an associated main access point 1112, a plurality of subpanels (or secondary panels) 1130-1 . . . 1130-N coupled to the main panel 1110 via respective conduits 1120-1 . . . 1120-N and having respective subpanel/secondary access point 1132-1 . . . 1132-N. As further shown in FIG. 11, each subpanel 1120-1 . . . 1120-N and respective subpanel access point 1132-1 . . . 1132-N is coupled to a variety of user terminals. For example, subpanel 1120-1 and respective subpanel access point 1132-1 are coupled to user terminals A1-A3 via a first common power line and further coupled to user terminals B1-B3 via a second common power line. Similarly, subpanel 1120-N and respective subpanel access point 1132-N are coupled to user terminals C1-C4 via a third common power line.

In a first exemplary operation, it should be understood that data can move in two directions: downstream (towards the various UTs) and upstream (toward the main wiring panel 1110). As a particular communication signal moves from the main access point 1112 to user terminal A1, each packet of information may need to be transmitted twice: first from the main access point 1112 to subpanel access point 1130-1 and again from subpanel 1130-1 to user terminal A1. Similarly, in an upstream direction from user terminal A1 to the main access point 1112, each packet of information may need to be transmitted twice: first from user terminal A1 to subpanel access point 1130-1 and again from subpanel 1130-1 to the main access point 1112.

Because the power line is a shared medium, such “double posting” requires twice as much bandwidth as a single posting directly between the main access point 1112 and a given user terminal. However, due to the large size of the power line network as a whole, it may not be practical or even possible to directly communicate in such a fashion. While a dedicated communication line, such as an Ethernet link between the main access point 1112 and a subpanel access point may alleviate the additional bandwidth use, running such a communication line may not be possible or practical. Accordingly, in various embodiments where user terminal A1 needs to communicate with user terminal C1, as many as four broadcasts may be necessary for each packet sent and received with the justifying factors including a lower cost of establishing a newtork.

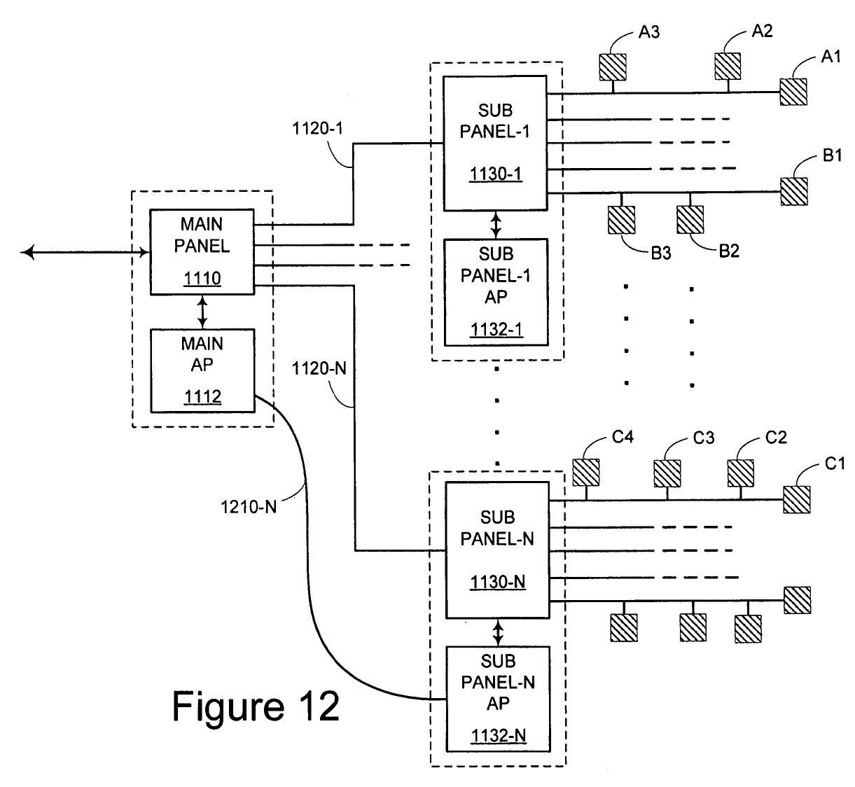

Continuing to FIG. 12, a second exemplary network is depicted where a dedicated non-power line communication link 1210-N is added to a system where such communication links are sometimes possible/practical between the main access point 1112 and a subpanel access point. Such a hybrid system represents a compromise between costs and performance: the cost coming from the initial outlay of communication link 1210-N; the increased performance coming from having one or two less postings on the power line for each packet transmitted.

In the exemplary embodiment of FIG. 12, communication link 1210-N is a standard Ethernet link. However, in various other embodiments, communication link 1210-N can take any number of known or later developed forms, such as a wireless link, a fiber-optic link, a T1 or E1 link and so forth.

In situations where a first access point has a plurality of communications conduits to a second access point, it should be appreciated that it is probably advantageous to endow such an access point with enough adaptive programming so as to pick the better/best conduit. In various embodiment, such an access point could favor the non-power line conduit so as to save power line bandwidth and possible take advantage of faster throughput available on the non-power line conduit.

However, it should also be appreciated that always choosing to use a non-power line conduit might not be the optimal choice in situations where the non-power line conduit is excessively taxed with data as compared to the power line conduit, or where the non-power line conduit is riddled with excessive noise and/or errors.

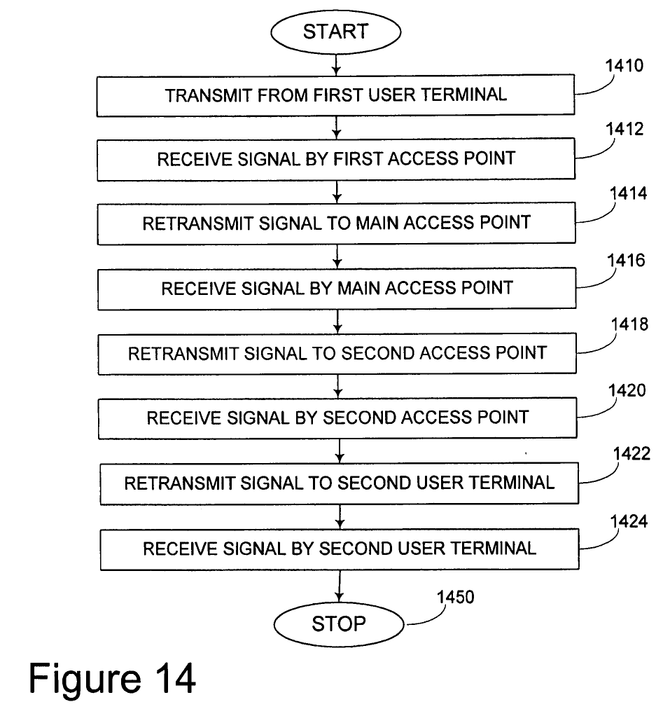

Jumping ahead to FIG. 14, it should be appreciated that FIG. 14 is a flowchart outlining an exemplary operation where each packet transmitted from one user terminal to a second user terminal is controlled by the main panel access point 1112 and where each packet must pass through the main panel access point 1112. The process starts in step 1410 where a packet of information is transmitted from a first user terminal to a first access point; the first access point typically being located at a subpanel wiring center associated with the user terminal. Next, in step 1412, the first packet is received by the first access point. Control continues to step 1414.

In step 1414, the packet of steps 1410-1412 is retransmitted from the subpanel access point to a main access point, and in step 1416, the retransmitted packet is received by the main access point. As discussed above with respect to FIGS. 11 and 12, steps 1414 and 1416 may in various embodiments take place over a power line conduit or any number of available non-power line conduits. Further, as the use of a non-power line conduit is generally more likely to provide better performance, the exemplary methods and systems may favor the exclusive or extensive use of non-power line conduits when possible. However, reminding one that such a choice may not provide the best overall performance, such a choice is not dispositive in all envisioned embodiments. Control continues to step 1418.

In step 1418, the packet of steps 1410-1416 is retransmitted from the main access point to a second subpanel access point (or alternatively back to the first access point), and in step 1420, the retransmitted packet is received by the second subpanel access point. As with steps 1414 and 1416, the transfer of data may take place over a power line conduit or any number of available non-power line conduits using decision similar rules discussed above with respect to steps 1414-1416. Control continues to step 1422.

In step 1422, the packet of steps 1410-1420 is retransmitted from the second access point to a second user terminal, and in step 1424 the packet is received by the second user terminal. Control then continues to step 1450 where the process stops.

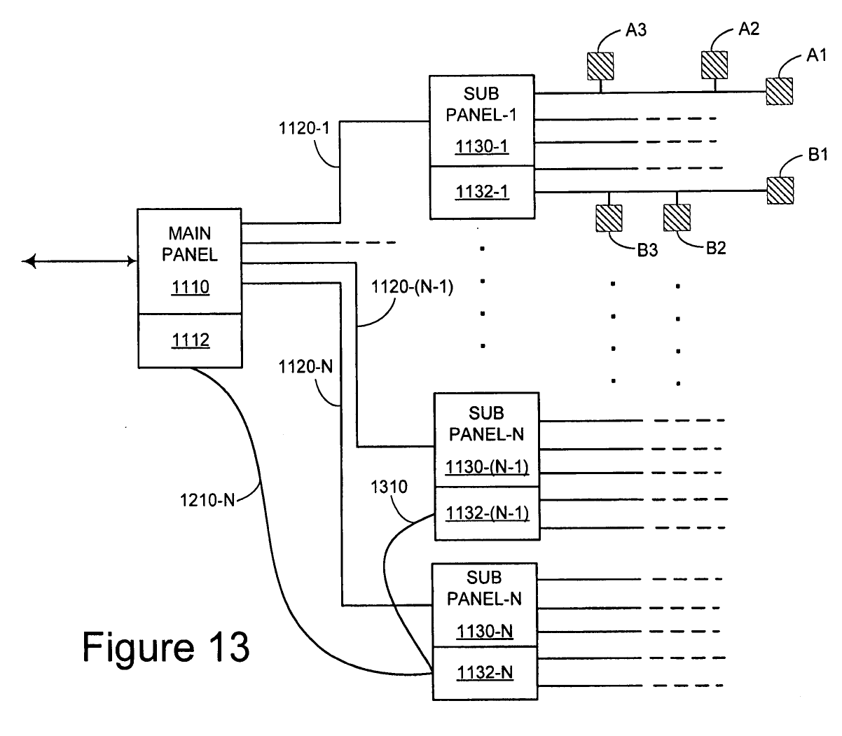

Jumping back to FIG. 13, it should be appreciated that the hybrid combination of redundant power line communication conduits and non-power line conduit options described in FIG. 12 (and associated text) can be extended to include non-power line communications conduits between subpanel access points. For example, as shown in FIG. 13, the communications system of FIG. 12 is modified to include a communications link 1310 between subpanel 1130-N and 1130-(N-1). In various embodiments link 1310 may simply represent a secondary, non-power line communication link between access point 1130-(N−1) and the main access point 1112.

However, in various embodiments where the restriction that all data packets must pass through the main access point (assuming that it is also the primary access point of the network) is not enforced, such a link can add further performance to the overall network.

By further lifting any restrictions as to which device can directly communicate with another given device, it should be appreciated that enforcing a more flexible communication paradigm might provide a more capable network.

For example, referring to FIGS. 11-13, it should be appreciated that it might be beneficial for user terminal A1 to directly communicate with user terminal A2, rather than require each packet be routed through one or both of subpanel access point 1132-1 and the main access point 1112, as a single posting on the power line is often more efficient that using multiple posts.

Still further, it can be advantageous to require packets transmitted between two user terminal having a common subpanel access point, but not a common conductor, to only use the relevant subpanel access point and not the main access point 1112. For example, a packet transmitted from user terminal A1 to user terminal B1 may reduce the need for as many as two posts by eliminating the need to use the main access point 1112.

Using the above-mentioned shortcuts has some disadvantageous in that each access point or each user terminal may need added processing power and intelligent programming to perform as described, but the increased performance of the overall power line network will be improved in exchange.

However, in view of the above-mentioned added expenses, it may not be practical to fully enable a network. That is, it may be economical to appropriately endow each access point, but not economical or other wise possible to appropriately enable the user terminals. Accordingly, in such embodiments it should be appreciated that the resultant power line network may require a restriction of direct user terminal-to-user terminal communications, i.e., all terminal-to-terminal communications may require the intervention of at least one subpanel access point.

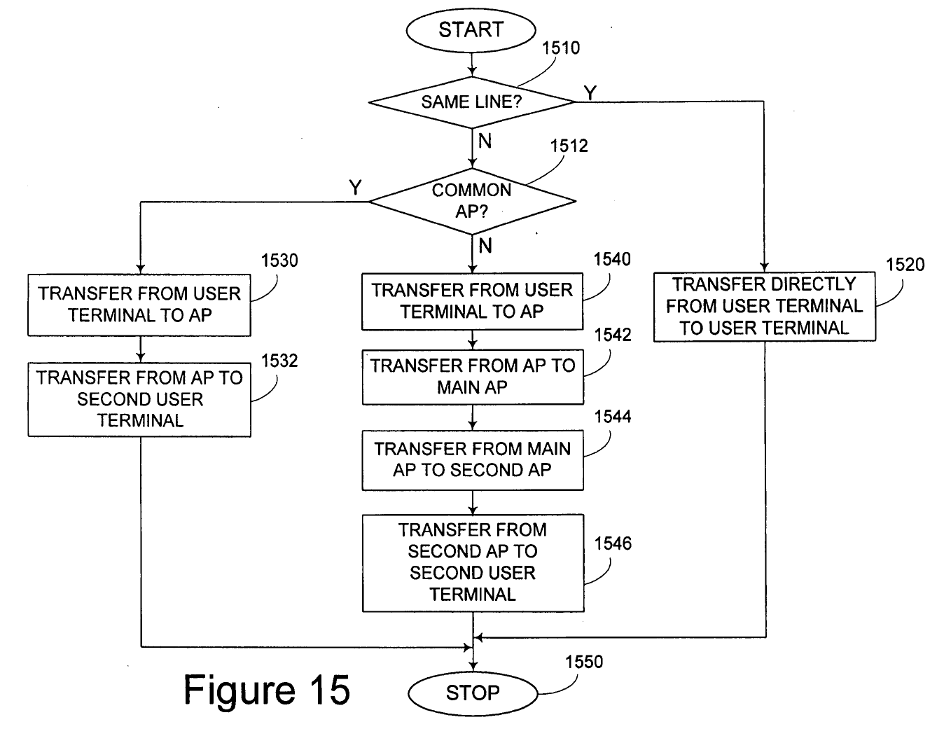

FIG. 15 is a flowchart outlining an exemplary operation for omitting multiple posts in a power line network such as those shown in FIGS. 11-13. The process starts in step 1510 where a determination is made as to whether a communication between two user terminals is one that occurs between user terminals on a common power line. If there is a common line, control jumps to step 1520; otherwise, control continues to step 1512. In step 1520, a direct data transfer is made between the two user terminals, and control continues to step 1550 where the process stops.

In step 1512, a determination is made as to whether the two user terminals share a common subpanel/secondary access point. If the user terminals share a common subpanel access point, control jumps to step 1530; otherwise, control continues to step 1540. In step 1530 a first transfer is made between the first user terminal to the subpanel access point, and in step 1532, a second transfer is made from the relevant access point to the second user terminal. Control then continues to step 1550 where the process stops.

In step 1540, which assumes that the user terminals share neither a common conductor or common subpanel access point, a first transfer is made from the first user terminal to its respective subpanel access point. Next, in step 1542, the data transferred in step 1540 is retransmitted from the subpanel access point to the main access point. Control continues to step 1544.

In step 1544, the data transferred in steps 1540-1542 is again transmitted; this time between the main access point and a second subpanel access point. Next, in step 1546, the data is transmitted from the second access point to the second user terminal, and control continues to step 1550 where the process stops.

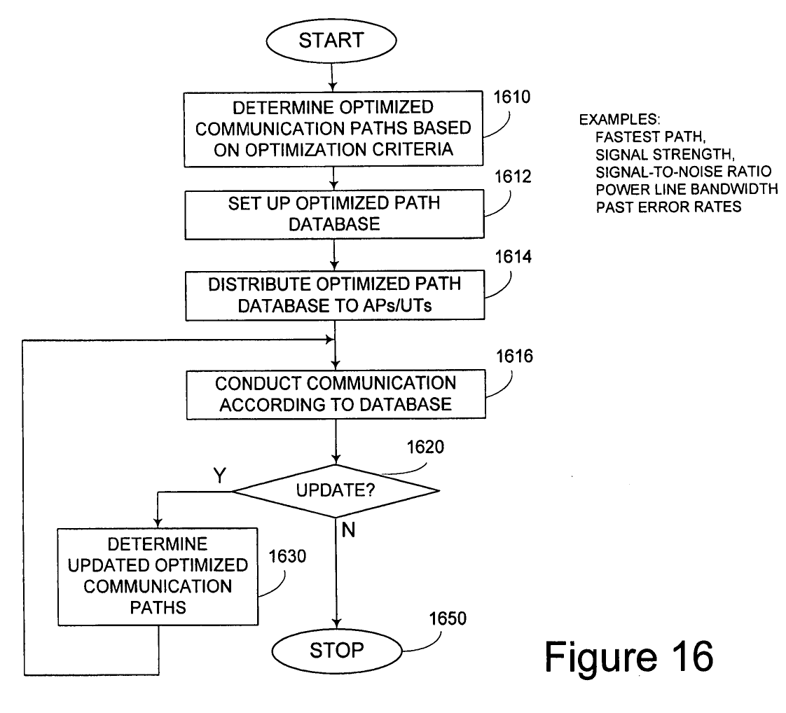

FIG. 16 is a flowchart outlining an exemplary operation for substantially optimizing traffic over the power line networks shown in FIGS. 11-13. In contrast to the flowchart of FIG. 15, which derives data flow based on topology, the flowchart of FIG. 16 derives data paths based on some performance criteria. For example, referring to FIG. 11, it may be preferable for user terminal A3 to talk directly to user terminal B3, but also preferable to route messages between terminals A1 and B1 through access terminal 1132 given the disparate signal-to-noise ratios between the two sets of user terminals.

Similarly a communication link between user terminal A1 and user terminal C1 might best be routed from subpanel access point 1232-1 to subpanel access point 1132-N rather that use the main access point 1112. However, the placement communication line 1210-N (FIG. 12) may change the balance in favor of routing through the main access point 1112. While developing and deploying a set of useful optimization rules can get complex very quickly, it should nonetheless be appreciated that even a very rudimentary set of rules can provide a network having increased performance.

Returning to FIG. 16, the process starts in step 1610 where optimized communication paths are determined based on some optimization criteria. In various embodiments, such criteria can include overall fastest path determinations, signal strength between two terminals, signal-to-noise ratio between two terminals, power line bandwidth considerations and measured (or predicted) error rates between two terminals. However, it should be appreciated that the particular nature of the optimization criteria can change to be any combination of any factors useful for determining such paths. Control continues to step 1612.

In step 1612, a database of optimized paths is established based on step 1610. Such a database could include, for example, designated paths for pair of user terminals and/or a set of rules. However, the exact nature of the database can vary from embodiment to embodiment as may be necessary or preferable by design. Next, in step 1614, the database (or at least the appropriate portions of the database) can be distributed to each of the user terminals and access points such that each device can readily establish the requisite paths. Control continues to step 1616.

In step 1616, communication between the various user terminals is conducted according to the information set forth in the distributed database. Next, in step 1620, a determination is made as to whether to update the database to account for various pertinent circumstances, e.g., changing noise patterns or excessive errors. If an update is desired, control jumps to step 1630; otherwise, control continues to step 1650 where the process stops.

In step 1630, new optimized communication paths are established (with resultant database), and control jumps back to step 1616 where further communications are conducted.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods to communicate over power lines.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system for communicating over a power wiring structure that includes a plurality of wiring centers, wherein each wiring center is associated with a respective plurality of user terminals and each user terminal is connected to the power wiring via an electrical outlet, the system comprising:
a plurality of communication access points with each access point installed in a respective wiring center.

2. The system according to claim 1, wherein communication is provided between any two user terminals via at least one access point.

3. The system according to claim 1, wherein each of the plurality of communication access points are in communication with each of the other communication access points.

4. The system according to claim 3, wherein each of the plurality of communication access points are in communication with each of the other communication access points through an Ethernet standard connection.

5. The system according to claim 3, wherein one of the plurality of communication access points is a primary access point that controls all communication signals between the user terminals.

6. The system according to claim 5, wherein all communication signals pass through the primary access point.

7. The system according to claim 5, wherein the plurality of user terminals each include a microprocessor, a non-power-line interface and a power line carrier interface.

8. The system according to claim 7, wherein the non-power-line interface is an Ethernet interface.

9. The system according to claim 3, where each access point communicates with the other access points through an Ethernet hub structure.

10. The system according to claim 3, where each access point is associated with the other access points through an Ethernet switching device.

11. A method for communicating over a power wiring structure that includes a plurality of wiring centers, wherein each wiring center is associated with a respective plurality of user terminals and each user terminal is connected to the power wiring via an electrical outlet, the method comprising:
receiving a first communication by a first access point located at a first wiring center from a first user terminal associated with the first access point.

12. The method according to claim 11, further comprising passing the information of the first communication from the first access point to a second user terminal associated with the first access point.

13. The method according to claim 11, further comprising passing the information of the first communication from the first access point to a second access point located at a second wiring center.

14. The method according to claim 11, wherein the step of passing the information of the first communication from the first access point to the second access point is performed over a non-power line communication interface.

15. The method according to claim 14, wherein one of the first and second access points is a primary access point responsible for controlling all communications between user terminals.

16. The method according to claim 14, wherein the non-power line communication interface is an Ethernet interface.

17. The method according to claim 14, wherein each access point includes a microprocessor, an Ethernet interface and a power line carrier interface.

18. The method according to claim 16, wherein the Ethernet standard connection includes an Ethernet switching device.

19. A system for local area network communications over an AC power wiring structure that includes a plurality of logical wiring centers each associated with a plurality of electrical outlets, the system comprising:
a plurality of communication access points each installed in a respective one of the plurality of logical wiring centers, the logical wiring centers being connected with each other with Ethernet standard connections;
wherein each access point is configured to receive communications signals from a plurality of user terminals via the plurality of electrical outlets; and
wherein communication is provided between any two of a plurality of devices via the user terminals though a non-power-line connection mechanism.

20. A method for communication among a plurality of end points of an AC power wiring structure, the method comprising the steps of:
inserting an electrical communication signal into an originating one of the end points to be sent to at least one destination end point;
passing the signal to at least one intermediate access point associated with a wiring center for a first group of the end points of the AC power wiring structure;
providing Ethernet standard communication between the first intermediate point and at least a second intermediate point associated with at least a second wiring center for at least a second group of end points of the low-voltage AC power wiring structure;
wherein when the electrical communication signal is destined for only end points of the first group, the communication is passed entirely as a carrier signal on a power line of the AC power wiring structure.

21. A system for communicating over a power wiring structure that includes a main wiring center connected to a plurality of secondary wiring centers and wherein each secondary wiring center is associated with a respective plurality of user terminals and each user terminal is connected to the power wiring via an electrical outlet, the system comprising:
a main communication access point installed in the main wiring center; and
a plurality of secondary communication access points with each secondary access point installed in a respective secondary wiring center;
wherein each of the plurality of secondary communication access points are in communication with the main communication access point.

22. The system according to claim 21, wherein communication is provided between any two user terminals via a first secondary access point over the power wiring structure.

23. The system according to claim 21, wherein communication is further provided between the first secondary access point and the main access point over the power wiring structure.

24. The system according to claim 23, wherein at least two of the plurality of secondary access points are in communication with each other via the main access point.

25. The system according to claim 24, wherein at least two of the plurality of secondary access points are in communication with each other via a non-power line communication interface.

26. The system according to claim 23, wherein one of the main access point is a primary access point that controls all communication signals between the user terminals.

27. The system according to claim 26, wherein all communication signals pass through the main access point.

28. The system according to claim 25, wherein at least two of the access points include a non-power-line interface and a power line carrier interface.

29. The system according to claim 28, wherein the non-power-line interface is an Ethernet interface.

30. The system according to claim 29, wherein each access point communicates with the other access points through an Ethernet hub structure or through an Ethernet switching device.

31. A system for communicating over a power wiring structure that includes a main wiring center connected to a plurality of secondary wiring centers and wherein each secondary wiring center is associated with a respective plurality of user terminals and each user terminal is connected to the power wiring via an electrical outlet, the system comprising:
a main communication access point installed in the main wiring center; and
a plurality of secondary communication access points with each secondary access point installed in a respective secondary wiring center;
wherein each of the plurality of secondary communication access points are in communication with the main communication access point; and
wherein communication between at least two user terminals does not pass through the main access point.

32. The system according to claim 31, wherein the communication system is configured to allow direct communication between two user terminals located on a common power line.

33. The system according to claim 32, wherein the communication system is further configured to allow communication between two user terminals having a common secondary access point but no common power line by first transferring data from a first user terminal to the secondary access point, then transferring the data from the secondary access point to a second user terminal.

34. The system according to claim 33, wherein the communication system is further configured to allow communication between two user terminals having no common secondary access point by routing data through the main access point.

35. The system according to claim 34, wherein the communication system is further configured to allow communication between two user terminals having no common secondary access point by routing data through the main access point and at least one secondary access point.

36. A system for communicating over a power wiring structure that includes a main wiring center connected to a plurality of secondary wiring centers and wherein each secondary wiring center is associated with a respective plurality of user terminals and each user terminal is connected to the power wiring via an electrical outlet, the system comprising:
a main communication access point installed in the main wiring center; and
a plurality of secondary communication access points with each secondary access point installed in a respective secondary wiring center;
wherein each of the plurality of secondary communication access points are in communication with the main communication access point; and
wherein at least one communication path between a first and second user terminal is determined based on an optimization criteria.

37. The system according to claim 32, wherein the optimization criteria includes at least one of fastest path, signal strength, signal-to-noise ratio, power-line bandwidth considerations and past error rates between the first and second user terminals.

38. The system according to claim 37, wherein the optimization criteria includes at least one of fastest path and signal-to-noise ratio.

39. The system according to claim 38, wherein path optimization is periodically updated.

40. The system according to claim 37, wherein path optimization criteria is constrained to always include at least one access point.

41. A system for communicating over a power wiring structure that includes a main wiring center connected to a plurality of secondary wiring centers and wherein each secondary wiring center is associated with a respective plurality of user terminals and each user terminal is connected to the power wiring via an electrical outlet, the system comprising:
a main communication access point installed in the main wiring center; and
a plurality of secondary communication access points with each secondary access point installed in a respective secondary wiring center;
wherein each of the plurality of secondary communication access points are in communication with the main communication access point; and
wherein the communication system employs at least a first non-power line communication conduit.

42. The system according to claim 41, wherein the first non-power line communication connects the main access point to a secondary access point.

43. The system according to claim 41, wherein the first non-power line communication connects between two secondary access points.

44. The system according to claim 42, further comprising a second non-power line communication that connects between two secondary access points.

45. The system according to claim 42, further comprising a second non-power line communication that connects between two secondary access points.

46. The system according to claim 41, wherein at least one access point has a power line interface, a non-power line interface and is adaptively configured to use one of the interfaces.

47. The system according to claim 41, wherein at least one access point has a power line interface, a non-power line interface and is adaptively configured to use the non-power line interface when possible.
